(19) United States
(12) Patent Application Publication
(10) Pub. No.: US 2013/0011568 A1
(43) Pub. Date: Jan. 10, 2013

(54) APPARATUS AND METHOD FOR SPRAYING A SURFACE OF A SUBSTRATE

(75) Inventor: Marcus Lang, Schechingen (DE)

(73) Assignee: Wolfgang DAMBACHER, Aalen (DE)

(21) Appl. No.: 13/638,162

(22) PCT Filed: Mar. 31, 2011
(86) PCT No.: PCT/DE2011/000350

§ 371 Date: Sep. 28, 2012

(30) Foreign Application Priority Data
Apr. 1, 2010 (DE) 10 2010 013 909.2

(51) Int. Cl. B05B 13/02; B05D 1/02

(52) U.S. Cl. 427/421.1; 239/548; 118/313

(57) ABSTRACT

The invention relates to a device for spraying a surface of a substrate, wherein the device comprises at least one first spray nozzle for the supply of a fluid to the surface of the substrate to be treated and the first spray nozzle is arranged at a first distance from the substrate, wherein at least one second spray nozzle is arranged at a second distance from the substrate and a ratio of the second distance to the first distance is in a range from 0.1 to 0.8. At most a first volume flow of the fluid can be passed through the at least one first spray nozzle and at most a second volume flow of the fluid can be passed through the at least one second spray nozzle, wherein the ratio of the second volume flow to the first volume flow is in a range from 0.005 to 0.5.

The invention relates to an apparatus and a method for spraying a substrate.

In surface treatment, such as, for example, spraying of a substrate with a fluid, great demands are made, for one thing, on the precision of the treatment that can be achieved, and for another thing, for reasons of efficiency, the treatment period is supposed to be as short as possible. If the substrate is a circuit board, the surface treatment can comprise cleaning or rinsing, film development, copper etching, resist stripping, or the like.

It is known that with an increase in the intensity of the surface treatment, the treatment period does decrease, but at the same time, the precision of the treated structures that can be achieved becomes worse. If, for example, a circuit board laminated over its full area with copper, which board is provided with resist structures, is subjected to etching treatment, this can take place by means of spraying an etching agent onto the surface of the circuit board. If the intensity of spraying is increased, increased etching of the regions not provided with resist takes place, but in addition, the side walls of the copper tracks present under the resist are attacked. This effect is referred to as under-etching. Under-etching takes place all the more strongly, the more intensively material exchange occurs in the regions between the resist structures. A person skilled in the art will select a compromise between the precision of the conductor tracks that can be achieved and the treatment period, for this purpose. In practice, good results can certainly be achieved with this.

With an increasing reduction in the dimensions of conductor tracks and conductor track distances between one another, however, the difficulty arises that the regions between the conductor tracks are no longer completely freed of copper, so that an electrical short-circuit can occur between the tracks. By means of reducing the intensity of the etching treatment, it is possible that sufficient material exchange occurs even in narrow regions between conductor tracks. However, the treatment period increases significantly. Furthermore, at relatively small dimensions of the conductor track distances relative to one another, an error profile is added, which does not occur at greater distances of the conductor tracks from one another. This error profile can be described as follows: It is usual that a circuit board base material is roughened on its surface. The copper layer subsequently applied by means of lamination can anchor itself well mechanically in the depressions of the surface of the circuit board base material, so that not only a copper layer having an average thickness, but also fine branchings of copper in the surface edge of the circuit board base material occur. If etching takes place by means of spraying, using an etching fluid on the surface of the circuit board, then it is true that it is possible, in most cases, to remove the copper to all the way to the surface of the circuit board base material, from conductor tracks that run adjacent to and relatively close to one another. However, it is possible that the copper present in the branchings of the surface is not completely etched away and continues to remain. The cause lies in that the material exchange between the etching fluid and the copper is so slight in the fine branchings that the copper is not completely removed even at a relatively long treatment period. These fine copper residues in the branchings are disruptive during subsequent flow of current through a conductor track, because the signal quality is made worse and a relatively high noise signal occurs. Furthermore, there is the risk that the branchings reach from one conductor track all the way to the adjacent conductor track, so that in the case of flow of current through the conductor tracks, a short-circuit occurs between the two tracks.

It is therefore the task of the invention to create an apparatus and a method for spraying a substrate, with which structures having high surface quality and precision, with a simultaneously short treatment period, can be achieved.

This task is accomplished, for the apparatus, by means of the object of the independent claim 1, and, for the method, by means of the object of the independent claim 6. Advantageous further developments of the invention are the object of the dependent claims.

The apparatus according to the invention, for spraying a surface of a substrate, has at least one first spray nozzle for feed of a fluid onto the surface of the substrate to be treated, whereby the first spray nozzle is disposed at a first distance from the substrate. Furthermore, the apparatus has at least one second spray nozzle, which is disposed at a second distance from the substrate, whereby a ratio of the second distance to the first distance lies in a range of 0.1 to 0.8. According to the invention, a first volume stream of the fluid can be maximally passed through the at least one first spray nozzle, whereby a second volume stream of the fluid can be maximally passed through the at least one second spray nozzle, and the ratio of the second volume stream to the first volume stream lies in a range of 0.005 to 0.5.

Surface treatment of the substrate can take place in the usual manner with the at least one first spray nozzle at a first distance from the surface of the substrate. With the at least one second spray nozzle at a second distance, the result is achieved that this nozzle is disposed closer to the surface of the substrate, and thus a different material exchange between the fluid and the surface of the substrate can be achieved than with the first spray nozzle disposed at a first distance. According to the invention, only a fluid volume stream that amounts to 0.005 to 0.5 times the first fluid volume stream passes through the second spray nozzle. When etching conductor tracks, the flanks of the conductor tracks are hardly attacked at all by the low fluid volume stream of the second spray nozzle, so that under-etching of the conductor tracks is almost completely avoided. Because of the close distance of the second spray nozzle from the surface of the substrate, however, the copper in the fine depressions on the surface of the circuit board base material can be reached well. The lesser fluid volume stream through the second spray nozzle is sufficient to attack and dissolve the small amounts of copper in the depressions, so that greater precision of the structures to be produced on the surface of the substrate, with a simultaneously short treatment period, is achieved.

If all the spray nozzles were to be disposed at the relatively close distance from the circuit board, the material exchange as a whole would be too great at an unchanged, high volume stream, so that the required precision of structures could not be achieved, and under-etching would occur. According to the invention, however, at least one first spray nozzle with a first fluid volume stream and a first distance from the substrate, as well as at least one second spray nozzle with a lesser fluid volume stream at a closer distance from the surface of the substrate than the first spray nozzle are provided, so that in the apparatus according to the invention, intensive and “rough” etching is combined with weaker and finer etching.

The lesser fluid volume stream of the second spray nozzle can be achieved, for example, by means of a different nozzle type, in which fine atomization of the fluid occurs and thus very many and fine fluid droplets exit from the spray nozzle. In this way, the surface of the fluid that is active for a chemical reaction increases, and this is advantageous for etching away fine branchings of copper in the surface region of the circuit board base material.

In the case of the apparatus according to the invention, the substrate can be laid individually into the apparatus, then sprayed, and after spraying has ended, it can be removed from the apparatus again. Preferably, however, the apparatus is configured in such a manner that the substrate can be transported through the apparatus from an entry side having an entry opening to an exit side having an exit opening. In this way, the apparatus can be used as a pass-through system, in which the substrate to be treated is transported through the apparatus at a previously determined, constant speed, at the same time with the surface treatment. Therefore the apparatus is also suitable as a module in a production line.

The apparatus can be configured in such a manner that the substrate to be treated can be sprayed, when viewed in the transport direction, first by the at least one first spray nozzle, afterward by the at least one second spray nozzle, and afterward by at least one third spray nozzle, whereby the third spray nozzle exhibits a third distance from the substrate, and the third distance is equal to the second distance or greater than the second distance. Usual spraying of the surface of the substrate takes place with the first spray nozzle. More precise treatment of the surface of the substrate can take place with the second spray nozzle, which is disposed closer to the substrate than the first spray nozzle. The third spray nozzle is provided for the purpose of removing the reaction products produced by the treatment with the second spray nozzle as completely as possible. For this purpose, the third spray nozzle can be disposed at the same distance as or preferably at a greater distance than the second spray nozzle. Preferably, the fluid volume stream through the third spray nozzle is greater than through the second spray nozzle, so that the reaction products can be carried away within a short time.

According to a further development of the invention, the apparatus has a first half with the entry side and a second half with the exit side, whereby the at least one second spray nozzle is disposed only in the second half of the apparatus. In this way, the result is achieved that the at least one first spray nozzle for intensive surface treatment can be used in the first half, so that the precise treatment of the surface by the at least one second spray nozzle takes place only after it has passed through at least 50% of the width of the apparatus, in other words the first half. Preferably, the second spray nozzle is disposed in the last quarter of the second half with reference to the treatment segment in the apparatus, so that the substrate is treated by the at least one second spray nozzle after having passed through about 75% of the width of the apparatus.

Spraying of the substrate takes place in particularly effective manner if one of the at least one first spray nozzle and one of the at least one second spray nozzle are disposed adjacent to one another and at such a distance from one another that a spray region of the first spray nozzle does not touch a spray region of the second spray nozzle. In this way, no interaction comes about with possibly reinforcing or extinguishing effects by means of interferences, for example, thereby making it possible to adjust the surface treatment in well-defined manner.

The invention also relates to a method for spraying a surface of a substrate, whereby a fluid, which preferably has an etching medium enriched with ozone or a fluid that activates the surface of the substrate, is conveyed onto the surface of the substrate to be sprayed, by means of at least one first spray nozzle, whereby the at least one first spray nozzle is disposed at a first distance from the substrate, and fluid is conveyed by means of at least one second spray nozzle at a second distance from the substrate, whereby a ratio of the second distance to the first distance lies in a range of 0.1 to 0.8, whereby a first volume stream of the fluid maximally passes through the at least one first spray nozzle, and a second volume stream of the fluid maximally passes through the at least one second spray nozzle, whereby the ratio of the second volume stream to the first volume stream lies in a range of 0.005 to 0.5. A better material exchange can be achieved with the second spray nozzle, which is disposed closer to the surface of the substrate in comparison with the first spray nozzle, so that intensive and, at the same time, precise treatment is possible, at a short treatment period.

According to a further development of the invention, the substrate can be transported through the apparatus from an entry side having an entry opening to an exit side having an exit opening, whereby the substrate, when viewed in the transport direction, are sprayed first by means of the at least one first spray nozzle, afterward by means of the at least one second spray nozzle, and afterward by means of at least one third spray nozzle, which has a third distance from the substrate, whereby the third distance is equal to or preferably greater than the second distance. Therefore the apparatus can be used in a pass- through system having a constant transport speed, whereby the third spray nozzle brings about the result that the reaction products produced by use of the second spray nozzle are effectively transported away.

Further advantages and characteristics of the invention will be explained in greater detail below, for multiple embodiments, making reference to the figures, which show:

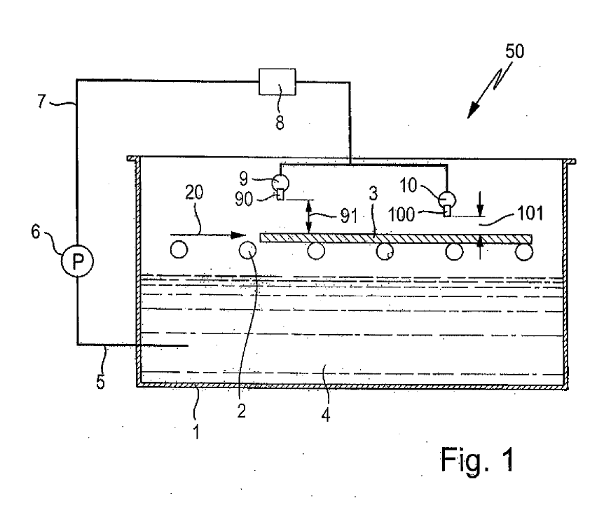

FIG. 1 a schematic representation of a first embodiment of the apparatus according to the invention;

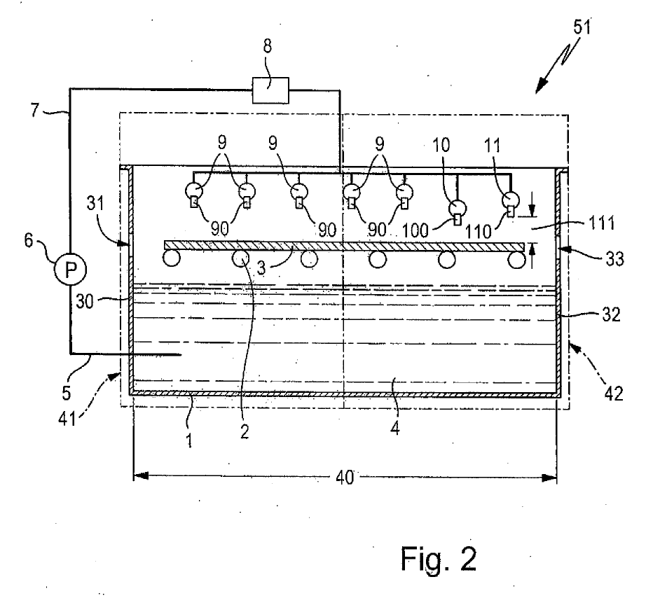

FIG. 2 a schematic representation of a second embodiment of the apparatus according to the invention;

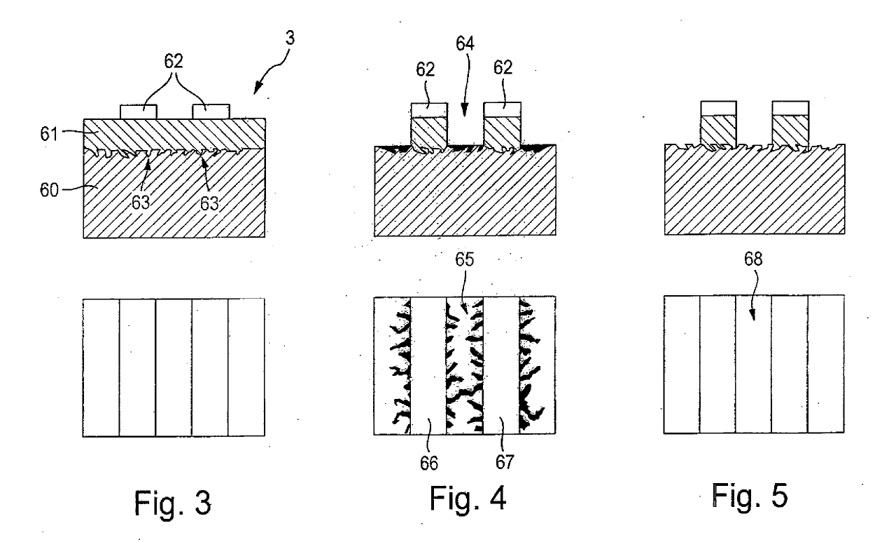

FIG. 3 a cross-sectional view and top view of a circuit board to be treated, before use of the method according to the invention;

FIG. 4 a cross-sectional view and top view of a treated circuit board after having passed through the at least one first spray nozzle of the apparatus according to the invention; and

FIG. 5 a cross-sectional view and top view of a treated circuit board after having passed through the at least one second spray nozzle of the apparatus according to the invention.

In FIG. 1, a schematic representation of a first embodiment of the apparatus 50 according to the invention is shown. The apparatus has a container 1 having support elements 2, on which a flat substrate 3 to be treated, such as, for example, a circuit board is disposed. In the container 1, a fluid 4 for etching the substrate 3 is situated, whereby the fluid 4 can be conveyed to a pump 6 by means of a line 5. At the exit of the pump 6, the fluid 4 can be passed to an ozone generator 8 by an additional line 7, where it is enriched with ozone and conveyed to spray pipes 9 and 10. The spray pipes 9 and 10 are provided with spray nozzles, out of which the fluid 4 can be sprayed in the direction toward the substrate 3. In the first embodiment of the invention, the spray pipe 9 has at least one first spray nozzle 90, which is disposed at a distance 91 from the substrate. The second spray pipe 10 has at least one second spray nozzle 100, which is disposed at a distance 101 from the substrate 3. In the embodiment shown in FIG. 1, the ratio of the distance 101 to the distance 91 amounts to about 0.5. If the substrate 3, in the form of a circuit board, is transported from the left to the right in the container 1, see arrow 20, spray treatment of the circuit board by the at least one first spray nozzle 90 takes place first. During further movement in the direction of the arrow 20, the circuit board gets into the spray region of the at least one second spray nozzle 100, which is disposed at a distance 101 closer to the surface of the substrate 3. According to a further development of the invention, further spray pipes 9 with further spray nozzles 90 can be provided adjacent to the spray pipe 9, at the same distance 91 from the circuit board 3, in each instance.

The first spray nozzle 90 can preferably be a flat jet nozzle with a spray angle of 30 to 90 degrees, which allows a maximal fluid volume stream of 1 to 5 liters per minute at a fluid pressure of 2 bar. The second spray nozzle 100 can be a conical jet nozzle with a spray angle of 120 degrees and a maximal fluid volume stream of 0.3 to 0.9 liters per minute at a fluid pressure of 2 bar. The second spray nozzle can also be a flat jet nozzle with a maximal fluid volume stream of 0.05 to 0.1 liters per minute at a fluid pressure of 2 bar. The second spray nozzle is configured in such a manner that the spray jet forms a finely atomized spray mist with fine spray droplets.

In FIG. 2, a second embodiment of an apparatus 51 according to the invention is shown, whereby in contrast to the first embodiment shown in FIG. 1, multiple first spray pipes 9 disposed parallel to one another, with first spray nozzles 90, and a third spray pipe 11 with at least one third spray nozzle 110 is provided. Furthermore, the second apparatus 51 has an entry side 30 having an entry opening 31 in the container 1, and an exit side 32 with an exit opening 33. The substrate 3 to be treated can therefore be transported into the container 1 from an entry side 30, through the entry opening 31, and can be transported through the exit opening 33 on the exit side 32, so that the apparatus 51 can form a module in a pass-through system with a constant transport speed. The substrate 3 is first sprayed by the first spray nozzles 90 when it enters into the container 1. Only after having passed through about 75% of the container width 40 does the substrate 3 get under the spray region of the second spray nozzle 10, which is disposed closer to the substrate 3.

Furthermore, a third spray nozzle 110 is placed at a distance 111 from the substrate 3, whereby the distance 111 is greater than the distance 101. The region that was previously sprayed by the second spray nozzle 90 can be rinsed out well by means of the fluid exiting from the third spray nozzle 110, so that reaction products, for example in the interstices of conductor tracks, are transported away.

The container 1 has a first half, see the dot-dash line 41 in FIG. 2, having the entry side 30, and a second half, see the dot-dash line 42 in FIG. 2, having the exit side 32, whereby the at least one second spray nozzle 10 is disposed only in the second half 42 of the apparatus 51. In this way, the result is achieved that the precise treatment of the substrate surface takes place not at the beginning, but rather only in the second half of the treatment period. Preferably, this precise treatment of the substrate surface takes place only toward the end of the treatment period, in a last quarter of the second half 42.

The effect of the method according to the invention is explained below, using FIGS. 3 to 5. In FIG. 3, a cross-section of a substrate 3 is shown in the upper view, and a top view is shown in the lower view. The substrate 3 has a base material 60, in the case of a circuit board, for example, FR-4, with a laminated copper layer 61. The copper layer 61 is also contained in depressions 63 of the surface of the base material 60. A resist material 62 is applied to individual regions of the copper layer 61. During etching treatment of the circuit board 3 by means of the first spray nozzles 90, the regions next to the resist 62 are etched until a channel 64 reaching to the surface of the circuit board has been formed; see the cross-sectional view in FIG. 4. The copper in the depressions 63 is then still present and forms fine branchings 65, as can be seen in the top view of FIG. 4. These branchings 65 can reach from one conductor track 66 to the adjacent conductor track 67, so that an electrical short-circuit between the two conductor tracks 66 and 67 is possible.

As can be seen from FIG. 5, the copper residues in the depressions 63 can be removed by means of the method according to the invention, to such an extent that no branchings 65 occur any longer; see reference symbol 68. In this way, electrical short-circuits or a high signal noise generated by the unclear edge width of the conductor track during charge transport through a conductor track can be avoided.

1. Apparatus for spraying a surface of a substrate, wherein the apparatus has at least one first spray nozzle for feed of a fluid onto the surface of the substrate to be treated and the first spray nozzle is disposed at a first distance from the substrate, wherein at least one second spray nozzle is disposed at a second distance from the substrate, and a ratio of the second distance to the first distance lies in a range of 0.1 to 0.8, wherein a first volume stream of the fluid can be maximally passed through the at least one first spray nozzle, and a second volume stream of the fluid can be maximally passed through the at least one second spray nozzle, wherein the ratio of the second volume stream to the first volume stream lies in a range of 0.005 to 0.5.

2. Apparatus according to claim 1, wherein the substrate can be transported through the apparatus from an entry side having an entry opening to an exit side having an exit opening.

3. Apparatus according to claim 2, wherein the substrate can be sprayed, when viewed in the transport direction, first by the at least one first spray nozzle, afterward by the at least one second spray nozzle, and afterward by at least one third spray nozzle, which has a third distance from the substrate, wherein the third distance is equal to the second distance or greater than the second distance.

4. Apparatus according to claim 2, wherein the apparatus has a first half with the entry side and a second half with the exit side, wherein the at least one second spray nozzle is disposed only in the second half of the apparatus.

5. Apparatus according to claim 1, wherein one of the at least one first spray nozzles and one of the at least one second spray nozzles are disposed adjacent to one another and at such a distance from one another that a spray region of the first spray nozzle does not touch a spray region of the second spray nozzle.

6. Method for spraying a surface of a substrate, wherein a fluid is conveyed onto the surface of the substrate to be sprayed, by means of at least one first spray nozzle, wherein the at least one first spray nozzle is disposed at a first distance from the substrate, and fluid is conveyed by means of at least one second spray nozzle at a second distance from the substrate, wherein a ratio of the second distance to the first distance lies in a range of 0.1 to 0.8, wherein a first volume stream of the fluid maximally passes through the at least one first spray nozzle, and a second volume stream of the fluid maximally passes through the at least one second spray nozzle, wherein the ratio of the second volume stream to the first volume stream lies in a range of 0.005 to 0.5.

7. Method according to claim 6, wherein the fluid has an etching medium enriched with ozone or a fluid that activates the surface of the substrate.

8. Apparatus according to claim 6, wherein the substrate is transported through the apparatus from an entry side to an exit side, and the substrate, when viewed in the transport direction, is sprayed first by means of the at least one first spray nozzle, afterward by means of the at least one second spray nozzle, and afterward by means of at least one third spray nozzle, which has a third distance from the substrate, wherein the third distance is equal to or greater than the second distance.
